(19) United States
(12) Patent Application Publication
(10) Pub. No.: US 2009/0259449 A1
(43) Pub. Date: Oct. 15, 2009

(54) DEVICE AND METHOD FOR FEDERATING AND INTEGRATING REAL OR SIMULATED SYSTEMS IN ORDER TO SIMULATE THE BEHAVIOR OF THE THUS DEVELOPED SYSTEM

(75) Inventor: Bertrand Franck, Courbevoie (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 12/160,406

(22) PCT Filed: Jan. 9, 2006
(86) PCT No.: PCT/EP2006/050089

§ 371 Date: Feb. 23, 2009

(51) Int. Cl. G06F 17/50

(52) U.S. Cl. 703/6

(57) ABSTRACT

A simulation and experimentation device, having one or more subsystems (1₁, 1₂, 1₃) are involved in a simulation of a given future system. For each subsystem (1₁, 1₂, 1₃) a data taking device (2₁, 2₂, 2₃), has a given profile. A central monitoring system (3) is designed for processing the data taken in order at least to synchronize them and manage their life-cycle. An experimentation platform (4) is adapted to support one or more models designed to simulate real systems or plans. The platform has an interface (4c) for monitoring and controlling the application of commands, and a means for carrying out steps. The platform has at least one application program (4p) designed to work out and monitor the additional classes of data to be aggregated to the entities resulting from the application of the models and/or work out various entities from the data coming from the central device (3), and/or work out simulation layers within the application program of the experimentation platform (4) from chosen parameters, synchronize and merge the layers with each other in order to produce a composite model.

### CROSS-REFERENCE TO RELATED APPLICATIONS

The present Application is based on International Application No. PCT/EP2006/2006/050089, filed on Jan. 9, 2006, and priority is hereby claimed under 35 USC §119 based on this application. This application is hereby incorporated by reference in their entirety into the present application.

### FIELD OF THE INVENTION

The present invention relates to a method and a device adapted for experimenting with and simulating (or making prototypes of) the behavior of systems developed from existing independent systems.

### BACKGROUND OF THE INVENTION

The device applies, for example, to the design and validating of system architectures of projects constructed from several lower level systems.

The prior art discloses various products such as computer simulation gateways, which enable different protocols to be simulated before being converted for application on a destination system.

The prior art also describes methods enabling the behavior of a new system developed from various subsystems to be simulated. The majority of these methods are intrusive. In general they entail coupling between the subsystems involved in the simulation, the need to develop a communications exchange standard, a mutual understanding of the meaning of the data exchanged and modification of the functional blocks of each subsystem.

The activities aiming to unite or couple currently existing simulation systems notably have the drawback of being intrusive.

### SUMMARY OF THE INVENTION

The present invention is based on a novel approach: a non-disruptive probe is positioned at each agent of the simulation. This probe recovers only the data necessary for this simulation; a device for collecting and processing the selected data is adapted to format these data before transmitting them to a simulation platform, which has its own environment in which the data will be processed.

The subject of the invention is a simulation device, at least the following elements:
one or more subsystems that are involved in a simulation of a given future system,
for each subsystem a data sampling device, the data having a given profile (list of data types to be sampled on a subsystem, associated with the manner of taking them [periodic, event-driven, on change of state, etc.]),
a central monitoring system designed for processing the data sampled in order at least to synchronize them and manage their life-cycle (creation, updating, deletion, etc.),
an experimentation platform adapted to support one or more models adapted to simulate real systems or plans, said platform comprising an interface for monitoring and controlling the application of commands, a means for carrying out steps, and
the platform comprising at least one application program designed to:
   work out and monitor the additional classes of data to be aggregated to the entities resulting from the application of the models; and/or
   work out various entities from the data coming from the central device,
   work out simulation layers within the application program of the experimentation platform from chosen parameters, synchronize and merge the layers with each other in order to produce a composite model.

The invention also relates to a method of simulating a future system developed from subsystems comprising one or more real or simulated objects, characterized in that it comprises at least the following steps: the gathering of data having a profile determined on the basis of the subsystems, the formatting of these data, the hosting of models by an experimentation platform comprising its environment, the application of one or more models to the formatted data and/or to data synthesized by the platform, the working out of simulation layers within the application program of the experimentation platform based on chosen parameters, the synchronization and the merging of the layers with each other in order to produce a composite model.

The invention notably has the following advantages:
only certain categories of data known in advance and necessary for the simulation are taken,
the interoperability required between the two systems is less demanding. There is no necessity to convert, to understand, to envisage the reactions and the responses to all the combinations of data and exchanges between the systems since the extent of what is accessible by the central system is limited voluntarily.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, a diagram of the architecture of the system according to the invention comprising a central monitoring system, various subsystems involved in the simulation operation and connection means associated with the entities, a local simulation platform,

FIG. 2, a variant of FIG. 1 with several layers,

FIG. 3, an example application involving several special response, fire-fighting and medical teams, etc.

### DETAILED DESCRIPTION OF THE INVENTION

The present invention described below may be used in any medical, civil or military field in which there is a need to simulate a new situation from various existing independent systems, whether remote or not.

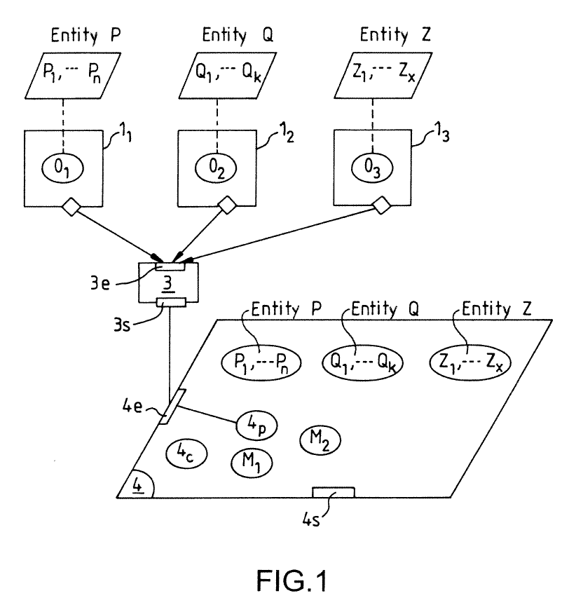

The architecture of the simulation system shown diagrammatically in FIG. 1 comprises, for example, several systems that are independent and remote from each other, 1₁ to 1ₘ, called subsystems, comprising several real or simulated objects O₁ to Oₘ. Each subsystem has parameters that are specific to it, {P₁, . . . Pₙ}, {Q₁, . . . Qₙ}, {Z₁, . . . Zₙ} respectively. Each subsystem 1₁ to 1ₘ is associated with a non-intrusive device, for example a collection agent, 2₁ to 2ₘ, which notably has the function of collecting certain monitored information belonging to the objects O₁ to Oₘ and of transmitting them to a central monitoring device for processing and managing 3 these data. The central monitoring device comprises an input interface 3e and an output interface 3s. The processed data are then transmitted to an experimentation platform 4 comprising its own environment, set out in detail below, notably including application programs 4p. The platform comprises an input interface 4e receiving the formatted data, an output interface 4s for data to which the models have been applied, and a monitoring and control interface 4c enabling commands to be taken into account during the experimentation to be applied and a means of execution that starts the experimentation loop (periodic or event-driven activation of the set of models).

A subsystem has its own application programs. The subsystem may be a simulation, a real system or even a hybrid system composed of simulation and of real systems.

The data collection agent, also called the “probe” below, is adapted to collect certain predefined data according to a given profile. The profile is defined as a list of data to be taken on a subsystem, associated with the manner of taking them (periodic, event-driven, on change of state). The probe delivers to the central monitoring device 3 certain information worked out by separate applications, programs, simulations, real and hybrid systems that are embedded in the subsystems 1₁ to 1ₘ. A probe may also allow variations in the values of selected parameters to be logged at the central monitoring device (application program of 3) which triggers an update of the parameters of the corresponding entities. It notably enables the new data values to be transmitted in case of variation or periodically, as dictated by the parametering of the associated profile.

Each probe annexed to a subsystem transmits, for example, the subsystem identifier and the set of data collected and selected.

The probes may be designed in such a way as to permit the flow of data only in one direction. This notably allows an intrusion of the central system on the distant system to be prevented in order to guarantee security. The probe may be a diode.

The central monitoring device 3 is, for example, a processor adapted to process the data in different ways. The processing involves, for example, their formatting before transmission to the experimentation platform or their synchronization.

The central monitoring device 3 takes, for example, the form of an application program which manages the life-cycle (creation, updating, deletion of entities and their behavior). It also manages the knowledge divided in the various layers of the global parameter space.

The central monitoring device 3 may be connected with stations preparing simulation or experimental scenarios, stations monitoring and supervising the carrying out of simulations, as well as tools for monitoring, displaying and analyzing results, which are not represented for the sake of simplicity.

The experimentation platform 4 comprises, for example, one or more processors 4p on which application programs run, adapted to create and develop various entities based on information coming from the central device 3 in an environment specific to the platform. The experimentation platform allows a behavior inherited from that of subsystems completed and constrained by behavioral elements synthesized by the application program of the platform to be applied to the models Mi. These processors are also adapted to synthesize data by means of an application program. The simulation layers are worked out from chosen parameters within the application program of the experimentation platform (4), and the layers are synchronized and merged with each other in order to produce a composite model.

The platform is designed to support various models with the selected and formatted data.

The means of visualizing results of simulations is, for example, a display wall based on cascadable back-projection modules. A part of this wall is, for example, touch-sensitive and enables direct tactile interaction with the entities displayed.

Operators may interact at the platform by means of interfaces not described in the figure.

The entities correspond to software representations of a real or virtual object belonging to the subsystems. This representation may be conceived of in the form of layers, each of which represents the space of possible variation of parameters characterizing the real or virtual object or its behavior. By way of nonlimiting example, an entity is, for example, a truck, its mobility parameters are located in the mobility layer, its ability to communicate in the communications layer.

The subsystems are linked with the central monitoring device, for example, by means of connection means, such as 2 Mb/s IP (Internet Protocol) connections for example, permitting data flows, the data possibly being enciphered.

The entire experimentation system may comprise a control station which, depending on simulation results, acts on the various subsystems in order to vary the profile of the data to be gathered.

Implementation of the method of the invention is carried out, for example, in the manner described below.

The overall experimentation carried out on the platform employs various agents represented (synthesized, modeled) by layer models. A simulation layer represents a parameter dimension (a degree of freedom, a subspace) of a characteristic of a model. The simulation layers are thus constructed and chosen in relation to parameters chosen in advance or in the course of operation. The parameters are, for example, the mobility layer which contains the spatial positions (x, y, z) and the speed coordinates (vx, vy, vz) of a subsystem or again communication layers containing transmitters/receivers (frequency, modulation, mode), network nodes (master, slave, relays, etc.), and protocols.

The various layers are, for example, synchronized with each other, then merged to produce an indivisible composite model, the behavior of which will be dictated by that of the parameters of the layers composing it, nevertheless respecting the overall constraints linked to the fact that the resultant model is indivisible. The model corresponds to a simulation or to the result of a simulation.

The monitoring device 3 uses information collected by the remote probes to create and generate entities in its own controlled environment, the generated layers being designated as remote entity layers. Due to the remote probes managing the functionalities, the parameter values are collected as soon as they vary and are transmitted to the construction unit of the central monitoring device which triggers an update of the parameters of the corresponding entities. Hence, the remote entity layers may be considered as views representing the behavior of parameters of separate external applications, programs, simulations, hybrid and real systems.

An application program of the central monitoring system notably has the capacity to develop and to monitor the additional classes of parameters that may be aggregated to the entities from remote entity layers in order to form other parameter layers.

The resultant entities have, on the one hand, behavior similar to their homologues in the remote systems in a given parameter space, and, on the other hand, complementary parameters behaving as directed by the centrally monitored system application.

The application program of the central device governs the life-cycle (creation, updating, deletion) of entities and their behavior thanks to the information and the knowledge divided in the various layers of the entire parameter space.

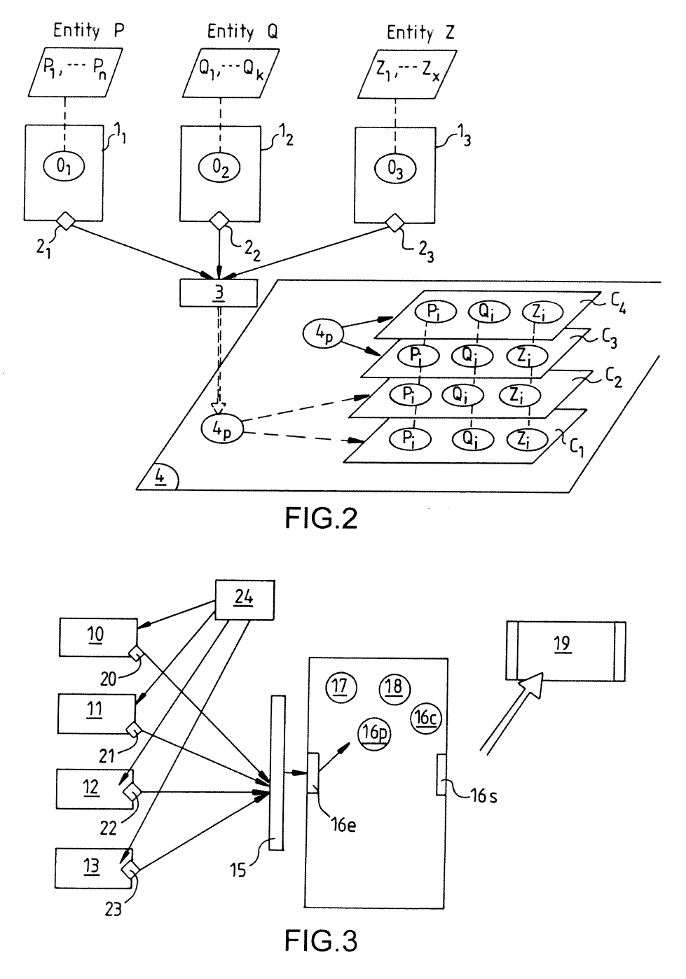

FIG. 2 is a diagram of the application where the layers may be of different kinds.

C1 and C2 correspond to remote entity layers monitored by the central monitoring device, then developed by the application program of the platform 4. The behavior of the parameters of the remote systems considered in the application are duplicated.

C3 and C4 correspond to different types of additional layer coming directly from the application program of the platform 4.

FIG. 3 represents an example of an application where the subsystems are composed:
of a simulated team 10 of firefighters. The known parameters are, for example, the number of vehicles, the capacity of each vehicle etc.
a real team 11 of firefighters.
an emergency medical unit 12 composed, for example, of vehicles, ambulances, helicopters, caregivers, materials, etc.
a national police team 13, composed, for example, of light vehicles, special response helicopters, special response agents.
a civil engineering team 14, composed, for example, of operatives and clearing machinery.

A profile of the data to be selected is fixed.

The implementation of the method according to the invention takes place in the following manner:
The subsystems transmit information corresponding to the fixed profile, via the probe 20, 21, 22, 23, to the central processor 15. The latter processes the data gathered, it synchronizes them and converts them into a homogeneous format with a view to future processing.
The formatted data are then transmitted to an experimentation platform 16 comprising an input interface 16e, an output interface 16s, a monitoring and control interface 16c, a processor 16p having the same functions as the processor 4p (FIG. 1). The processor 16p is designed to apply different models.

The models employed may be:
a model of capacity 17: fire extinguishing capacity, heat resistance capacity etc.
a fire protection team model 18.

The results of applying models to the data are transmitted, for example, to a screen 19. A monitoring and control station 24 enables intervention by various teams based on simulation results.

The platform may also comprise crisis control models, a population evacuation model, a congestion model, etc.

The models applied generate several layers of entities representing the behavior of selected parameters in the environment of the experimentation platform following application of a model.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1-9. (canceled)

10. A simulation device, comprising:
one or more subsystems that are involved in a simulation of a given future system,
for each subsystem a data taking device associated therewith, the data associated with each of the data taking devices having a given profile, said data device is adapted to transmit the new data values in case of variation or periodically, dictated by the parametering of the associated profile,
a central monitoring system designed for processing the data taken in order at least to synchronize them and manage their life-cycle,
an experimentation platform adapted to support one or more models designed to simulate real systems or plans, said platform comprising an interface for monitoring and controlling the application of commands, a means for carrying out steps,
the platform comprising at least one application program adapted to:
work out and monitor the additional classes of data to be aggregated to the entities resulting from the application of the models; and/or
work out various entities from the data coming from the central device,
work out simulation layers within the application program of the experimentation platform from chosen parameters, synchronize and merge the layers with each other in order to produce a composite model.

11. The device as claimed in claim 10, wherein each of the data taking devices is a device having a fixed data-flow direction.

12. The device as claimed in claim 10, wherein a subsystem is a simulated subsystem.

13. The device as claimed in claim 10, wherein a subsystem is a real subsystem.

14. The device as claimed in claim 10, wherein the subsystem is a hybrid subsystem.

15. A simulation system, comprising at least a device as claimed in claim 10, a device for displaying results and a control device linked to the various subsystems.

16. A method of simulating a future system developed from subsystems comprising one or more real or simulated objects, comprising the following steps:
taking of data having a profile determined on the basis of the subsystems, the formatting of these data, the hosting of models by an experimentation platform comprising its environment,
application of one or more models to the formatted data and/or to data synthesized by the platform,
working out of simulation layers within the application program of the experimentation platform based on chosen parameters, and
synchronizing the merging of the layers with each other in order to produce a composite model; and in that the variation of a piece of the data taken is into account in the formatting step.
